(19) United States
(12) Patent Application Publication
(10) Pub. No.: US 2016/0132188 A1
(43) Pub. Date: May 12, 2016

(54) PROCESSING METHOD OF SCREEN-DISPLAYED WINDOW AND MOBILE TERMINAL

(71) Applicant: MediaTek Singapore Pte. Ltd., Singapore (SG)

(72) Inventors: Jinlong Li, Hefei City (CN); Haifang Ma, Hefei City (CN)

(21) Appl. No.: 14/934,083

(22) Filed: Nov. 5, 2015

(30) Foreign Application Priority Data
Nov. 7, 2014 (CN) 201410624009.X

(51) Int. Cl. G06F 3/0481; G06F 3/0484; G06F 3/0488; G06F 3/0486

(52) U.S. Cl. CPC G06F 3/0481; G06F 3/0486; G06F 3/04845; G06F 3/04842; G06F 3/04883; G06F 2203/04803

(57) ABSTRACT

A processing method of screen-displayed windows and a mobile terminal includes: receiving a dragging instruction in regard to a frame of the screen; responding to the dragging instruction and deciding an initial position of the frame before dragging and a final position of the frame after dragging on the screen; when the initial position of the frame is close to or overlaps the outer frame of the screen and the distance between the final position of the frame and the outer frame of the screen is greater than a threshold value, a second display window is added on the screen.

### BACKGROUND

The present invention relates to mobile terminal technology field, and more particularly, to a processing method of windows displayed on the screen and mobile terminal.

Accompanying the rapid development of electronic products and fast changes in communication technology, mobile terminals, such as smart phones and tablets, have become indispensable. Along with the popularization of these technologies, many customers transfer their works from a PC to their mobile terminal, such as browsing a webpage, receiving/sending emails, and looking at media content.

Most current smart mobile terminals can only display one application program operation interface per display screen. Only a few mobile devices support a multi-window operation interface. Even products which do support this function, such as the Samsung Note series phone and tablet still have some flaws:
1. Adding or deleting a window is complicated due to the desktop style.
2. Performing operations via taskbar is necessary.
3. The position of multi-windows is default, and cannot be adjusted randomly.

### SUMMARY

The present invention provides a processing method of windows displayed on the screen and mobile terminal to solve the technical problems that exist when operating a multi-window operation interface on a mobile terminal.

To solve the abovementioned technical problems, a technical solution used in the present invention comprises: providing a processing method for windows displayed on the screen, wherein a first display window is displayed on the screen, and the first display window has a first frame and displays the first display content. The processing method comprises: receiving a dragging instruction in regard to a frame on the screen; responding to the dragging instruction and judging the initial position of the frame before dragging and the final position of the frame after dragging on the screen; when the initial position of the frame before dragging is close or overlapped to an outer frame of the screen, and the distance between the final position after dragging and the outer frame of the screen is greater than a threshold value, then adding a second window on the screen.

To solve the abovementioned technical problems, a technical solution used in the present invention comprises: providing a processing method of windows displayed on the screen wherein a screen of a mobile terminal displays a first display window and at least a second display window at the same time, the first display window displays a first display content, and each second display window displays the corresponding second display content, and the background of the mobile terminal comprises at least one backup third display content. The processing method comprises: receiving a dragging instruction at a point in the first display window of the screen; and replacing the first display content of the first display window with at least the backup third display content according to the initial position of the point before dragging and the final position of the point after dragging.

To solve the abovementioned technical problems, a technical solution used in the present invention comprises: providing a processing method of windows displayed on the screen wherein the screen displays a first display window and at least a second display window at the same time, the first display window displays a first display content, each second display window displays the corresponding second display content, and the background of the mobile terminal comprises at least a backup third display content, and the processing method comprises: receiving a closing instruction for closing the first display content; responding to the closing instruction and closing the first display content; and displaying at least the backup third display content.

To solve the abovementioned technical problems, a technical solution used in the present invention comprises: providing a mobile terminal, wherein the first display window displays a first display content, and the mobile terminal comprises a receiving module, a controlling module and a display module. The receiving module is arranged to receive the dragging instruction in regard to the frame on the screen. The controlling module is arranged to respond to the dragging instruction and judge the initial position of the frame before dragging and the final position of the frame after dragging on the screen. The display module is arranged to add a second display window on the screen when the initial position of the frame before dragging is close to or overlaps the outer frame of the screen, and the distance between the position of the frame after dragging and the outer frame of the screen is greater than a threshold value.

To solve the abovementioned technical problems, a technical solution used in the present invention comprises: providing a mobile terminal which comprises a receiving module, a controlling module and a display module. The receiving module is arranged to receive a dragging instruction in regard to a point in the first display window on the screen when a first display window and at least a second display window are displayed on the screen of the mobile terminal, and the first display window displays a first display content, each second display window displays the corresponding second display content, and the background of the mobile terminal comprises at least a backup third display content; the controlling module is arranged to respond to the dragging instruction and judge the initial position of the point before dragging and the final position of the point after dragging on the screen; the display module is arranged to replace the first display content of the first display window with at least a backup third display content according to the initial position of the point before dragging and the final position of the point after dragging.

To solve the abovementioned technical problems, a technical solution used in the present invention comprises: providing a mobile terminal which comprises a receiving module, a controlling module and a display module. The receiving module is arranged to receive a closing instruction for closing the first display content when a first display window and at least a second display window are displayed on the screen at the same time, and the first display window displays a first display content, and each second display window displays the corresponding second display content, and the background of the mobile terminal comprises at least a backup third display content; the controlling module is arranged to respond to the closing instruction and close the first display content; the display module is arranged to display at least the backup third display content in the first display window.

As compared to the prior art, the processing method and the mobile terminal of the present invention respond to customer instructions received by the receiving module via the controlling module, and control the display module to change the number of windows displayed on the screen and the display content displayed in the window. Through the abovementioned method, not only is a simple method of changing the number of windows on the screen provided, but the limitation that traditionally a taskbar is needed to change the display content of each window is solved, which makes the operation much easier, and enhances the customer experience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a processing method of windows displayed on the screen according to an embodiment of the present invention.

FIG. 2A, FIG. 2B, FIG. 3A, FIG. 3B, FIG. 4A, FIG. 4B, FIG. 5A, FIG. 5B, FIG. 6A, FIG. 6B, FIG. 7A and FIG. 7B are diagrams illustrating adjustment of a number of display windows applying the processing method shown in FIG. 1.

FIG. 8 is a flowchart illustrating a processing method of windows displayed on the screen according to another embodiment of the present invention.

FIG. 9A, FIG. 9B, FIG. 10A and FIG. 10B are diagrams illustrating the adjustment of the number of display window applying the embodiment of processing method of screen displayed window in FIG. 8.

FIG. 11A and FIG. 11B are diagrams illustrating adjustment of the area of the screen-displayed window according to an embodiment.

FIG. 12 is a flowchart illustrating a processing method of windows displayed on the screen according to another embodiment of the present invention.

FIG. 13A, FIG. 13B, FIG. 14A and FIG. 14B are diagrams illustrating the exchange of content of the screen displayed window.

FIG. 15 is a flowchart illustrating a processing method of windows displayed on the screen according to another embodiment of the present invention.

FIG. 16A and FIG. 16B are diagrams illustrating adjustment of the number of display windows applying the processing method of FIG. 15.

FIG. 17 is a flowchart illustrating a processing method of windows displayed on the screen according to another embodiment of the present invention.

FIG. 18A and FIG. 18B are diagrams illustrating the number of adjustments of display windows applying the processing method of FIG. 17.

FIG. 19A and FIG. 19B are diagrams illustrating adjustment of the number of display windows.

FIG. 20 is a diagram illustrating the structure of a mobile terminal according to an embodiment of the present invention.

### DETAILED DESCRIPTION

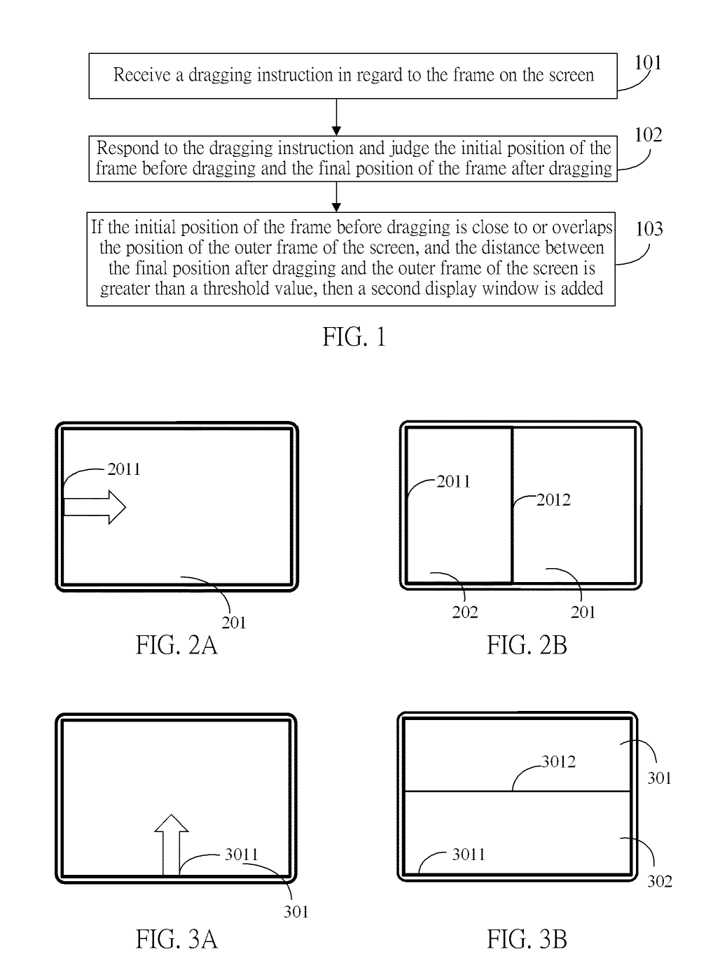

Refer to FIG. 1, which is a flowchart illustrating a processing method of windows displayed on the screen according to an embodiment of the present invention. The steps of the processing method are detailed in the following.

Step 101: receive a dragging instruction in regard to the frame on the screen.

The mobile terminal needs to first receive the dragging instruction in regard to the frame on the screen from the customer in order to display a plurality of windows on the screen-displayed window at the same time or randomly change the number of displayed display windows, wherein the dragging instruction comprises the initial position before dragging, the dragging direction and the final position after dragging.

Step 102: respond to the dragging instruction and judge the initial position of the frame before dragging and the final position of the frame after dragging.

The mobile terminal confirms the initial position before dragging, the dragging direction and the final position after dragging according to the dragging instruction, then responds to the dragging operation according to the abovementioned dragging instruction to make the selected frame reach the assigned final position after dragging.

Step 103: if the initial position of the frame before dragging is close to or overlaps the position of the outer frame of the screen, and the distance between the final position after dragging and the outer frame of the screen is greater than a threshold value, then a second display window is added on the screen.

FIG. 2A and FIG. 2B are diagrams illustrating the adjustment of the number of display windows applying the processing method of FIG. 1, wherein FIG. 2A illustrates the first display window displayed on the screen of the mobile terminal before the frame is dragged and FIG. 2B illustrates the first display window and the second display window displayed by the mobile terminal after the frame was dragged. The first display window has frames, such as a top frame, a bottom frame, a right frame and a left frame. For ease of description, the first display window and the second display window are defined as window 201 and 202, respectively.

For the example of the screen-displayed window being a square, when the initial position of the dragged frame before dragging 2011 is close to or overlaps the left side of the outer frame of the screen, and the distance between the initial position before dragging 2011 and the final position after dragging 2012 is greater than a threshold value, e.g. 1 cm, then the display window 202 is also displayed on the screen of the mobile terminal, wherein window 201 and window 202 use the final position of the dragged frame after dragging 2012 as a border. After dragging, the window 201 and window 202 are displayed on the screen at the same time.

In a preferred embodiment, in the dragging process of the frame, the content displayed in the window 201 adjusts the area dynamically according to the final position of the frame after dragging without affecting display of the content. Correspondingly, the proportion of the display content of window 202 adjusts with the area of the window, opposite to the proportion of window 201.

The dragging direction of the frame and the positions of the windows 201 and 202 shown in FIGS. 2A and 2B are just an example, and not a limitation, of the present invention.

Another embodiment shown in FIGS. 3A and 3B illustrates the adjustment of the number of display window applying the processing method of FIG. 1, wherein FIG. 3A is a diagram illustrating the first display window displayed on the screen of the mobile terminal before the frame is dragged and FIG. 3B is a diagram illustrating the first display window and the second display window displayed by the mobile terminal after dragging. For ease of description, the first display window and the second display window are defined as the windows 301 and 302, respectively.

In FIG. 3A and FIG. 3B, which illustrate the screen displayed window being square, when the initial position of the dragged frame is close to or overlaps the bottom of the outer frame of the screen, i.e. the final position after dragging 3012 is above the initial position, and the distance between the initial position and the final position is greater than a threshold value, e.g. 1 cm, the mobile terminal using the final position as a border displays the windows 301 and 302 on the screen at the same time after dragging, wherein the positions of the windows 301 and 302 are not limited. In another embodiment, when the initial position of the dragged frame before dragging is close to or overlaps the top of the outer frame of the screen, i.e. the final position after dragging is underneath the initial position, and the distance between the final position and the initial position is greater than 1 cm, e.g. 1 cm, the mobile terminal using the final position as a border displays the first display window and the second display window on the screen at the same time after dragging.

FIG. 4A, FIG. 4B, FIG. 5A and FIG. 5B are diagrams illustrating the adjustment of the number of display windows according to the embodiment illustrated in FIG. 1. FIG. 4A is a diagram illustrating the first display window and the second display window displayed on the screen of the mobile terminal before dragging and FIG. 4B is a diagram illustrating the first display window, the second display window and the third display window displayed by the mobile terminal after dragging. The first display window, the second display window and the third display window are defined as the window 401, the window 402 and the window 403, respectively.

In FIG. 4A, when the initial position of the dragged frame before dragging 4021 is close to or overlaps the outer frame of the screen, e.g. the bottom of the outer frame of the mobile terminal in FIG. 4A, the initial position of the dragged frame is located in the range of the second display window 402, the distance between the final position after dragging 4022 and the initial position is greater than a threshold value, e.g. 1 cm, the final position is above the initial position, and the dragging distance of the frame is greater than a threshold, e.g. 1 cm, a display window 403 is further added on the desktop using the initial position of the dragged frame as a border and the final position as another border.

FIG. 5A is a diagram illustrating the first display window and the second display window displayed on the screen of the mobile terminal before dragging, FIG. 5B is a diagram illustrating the first display window, the second display window and the third display window displayed by the mobile terminal after dragging. The first display window, the second display window and the third display window are defined as the window 501, the window 502 and the window 503, respectively.

When the initial position before dragging 5021 is close to or located at the intersection of the border of window 501 and window 502 and the bottom of the outer frame of the screen, the final position after dragging 5022 is above the initial position, and the dragging distance of the frame is greater than a threshold value, e.g. 1 cm, a display window 503 is further added on the desktop using the initial position of the frame as a border and the final position as another border.

The final position after dragging (4022 or 5022) is disposed above the initial position before dragging in the above examples, but this is not a limitation. One skilled person in the art can understand other alternative designs are also possible. In addition, the number of windows displayed by the mobile terminal is not a limitation. In other embodiments, even if the screen already displays three display windows, a fourth display window etc. can still be added via the abovementioned method.

FIG. 6A and FIG. 6B are diagrams illustrating the adjustment of the number of display windows. FIG. 6A is a diagram illustrating the first display window, the second display window and the third display window displayed on the screen of the mobile terminal before dragging, and FIG. 6B is a diagram illustrating the first display window, the second display window, the third display window and the fourth display window displayed by the mobile terminal after dragging. The first display window, the second display window, the third display window and the fourth display window are defined as the window 601, the window 602, the window 603 and the window 604, respectively.

When the initial position before dragging 6021 is located in the range of the second display window and close to or overlaps the right side of the outer frame of the screen, the final position after dragging 6022 is disposed at the left side of the initial position before dragging, and the dragging distance of the frame is greater than a threshold value, e.g. 1 cm, a fourth display window is further added on the desktop using the initial position of the frame as a border and the final position as another border.

The content displayed in the new window when the new display window is added is described as follows.

If the final position of the frame is located to the right of the initial position, as shown in FIGS. 2A and 2B, the content displayed in the window 202 is the content corresponding to the program opened before the program corresponding to the content is displayed in the window 201. In a preferred embodiment, the content displayed in window 202 is the program opened before the program corresponding to the content displayed in window 201 and also the program whose opening time is closest to the opening time of the display content of window 201. For example, if the customer opens a plurality of programs A₁, A₂, . . . , A_{N} during the process of using the mobile terminal (in which N is any integer greater than 1), wherein A₁ is the first program being opened, and A_{N} is the last program being opened, if the first display window 201 displays the content corresponding to program A_{N}, the second display window 202 will display the content corresponding to the program A_{N-1}. At this time, the programs A_{N-1} and A_{N} are called current activated programs, programs A₁, . . . , A_{N-2} are called background backup program, A₁, . . . , A_{N-2} constitute a background backup sequence, the corresponding display content is called background backup display content, and the plurality of backup display contents constitute a backup display content sequence. The present invention defines a background backup program sequence according to the order of opening time of the programs opened by a customer, and the background backup program sequence is arranged to confirm the content displayed in the new display window to avoid an extra taskbar being displayed on the screen as is needed traditionally.

In another example, if the final position of the frame is above the initial position, as shown in FIGS. 3A and 3B, the content displayed in window 302 is the content corresponding to the program opened before the program corresponding to the content displayed in the window 301. In a preferred embodiment, the content displayed in the window 302 is the program opened before the program corresponding to the content displayed in the window 301 and also the program whose opening time is the closest to the opening time of the display content of the window 301. For example, if the content displayed in the first display window 301 corresponds to program A_{N}, then the content displayed in the second display window 302 corresponds to program A_{N-1}. As shown in FIGS. 4A and 4B, if the content displayed in the first display window 401 corresponds to program A_{N}, the content displayed in the second display window 402 corresponds to program A_{N-1}, then the content displayed in the third display window 403 corresponds to program A_{N-2}. As shown in FIGS. 5A and 5B, if the content displayed in the first display window 501 corresponds to program A_{N}, the content displayed in the second display window 502 corresponds to program A_{N-1}, then the content displayed in the third display window 503 corresponds to program A_{N-2}.

In another example, if the final position of the frame is disposed to the left of the initial position, the content displayed in the new second display window on the screen is the content corresponding to the program opened after the program corresponding to the content displayed in the prior first display window. In addition, in a preferred embodiment, the program corresponding to the content displayed in the second display window is the program opened after the content displayed in the first display window and whose opening time is the closest to the opening time of the display content of the first display window. For example, as shown in FIGS. 6A and 6B, if the content displayed in the first display window 601 corresponds to program A_{N-3}, the content displayed in the second display window 602 corresponds to program A_{N-2}, and the content displayed in the third display window 603 corresponds to program A_{N-1}, then the content displayed in the fourth display window 604 corresponds to program A_{N}.

FIG. 7A and FIG. 7B are diagrams illustrating the adjustment of the number of display windows. FIG. 7A is a diagram illustrating a first display window displayed on the screen of the mobile terminal before the frame is dragged and FIG. 7B is a diagram illustrating a first display window and a second display window displayed by the mobile terminal after the frame is dragged. The first display window and the second display window are defined as the window 701 and the window 702, respectively.

When the initial position of the frame before dragging is close to the right side of the outer frame of the screen, and the final position after dragging 7012 is located on the left side of the initial position before dragging 7011 and the dragging distance is greater than a threshold value, e.g. 1 cm, using the final position after dragging as a boarder, the window 702 is added on the screen of the mobile terminal, and the window 702 should display the program opened immediately after the content displayed in the window 701. If the content displayed in the window 701 is the content of the last opened program A_{N}, the window 702 displays the desktop of the mobile terminal. Accordingly, the customer of the mobile terminal can introduce a new program A_{N+1} by clicking the icon on the desktop. In an example, the desktop is replaced with the display content of program A_{N+1} to display in the second display window 702. If the customer of the mobile terminal needs to introduce a new program again, similarly, a customer can drag the frame from the right side of the outer frame of the screen to add the third display window on the screen again, and the third display window displays the desktop for facilitating the customer to introduce programs which need to be displayed on the screen at the same time. The detailed description is omitted here.

In the above embodiments, the content displayed in the new second display window on the screen is the content corresponding to the program opened before the program corresponding to the content displayed in the prior first display window, if the final position of the frame is located on the right side of the initial position; the content displayed in the new second display window on the screen is the content corresponding to the program opened after the program corresponding to the content displayed in the prior first display window if the final position of the frame is disposed on the left side of the initial position. The above definition is only an example. The dragging direction described in the examples is only for explanatory purposes, and the program opened before or after the display content is only an example, not a limitation. As long as the mobile terminal can distinguish between the two, all the examples can be defined in the opposite way. Any method of dragging the frame from any place close to the outer frame of the screen to the center of the mobile terminal to add a screen displayed window falls within the scope of the present invention.

When the initial position of the dragged frame is in a specific range close to the outer frame, the mobile terminal confirms the initial position of the dragged frame is close to the outer frame of the screen. Therefore, as long as the distance between the initial position and the outer frame of the screen is smaller than a threshold value, the initial position is considered as close to the outer frame of the screen and also the processing method of the screen window is triggered. The specific threshold value described here is different from the threshold value described in above paragraph. The threshold value here is smaller, e.g. 0.5 cm. When the distance between the final position of the dragged frame and the initial position of the dragged frame is greater than a default threshold value, the above operating process for adding the second display window can be confirmed by the mobile terminal. Therefore, a default threshold value should be defined for the dragging distance to prevent erroneous adding of display windows. The default threshold value described here is greater than the specific threshold value described above, e.g. 1 cm.

As compared to the prior art, the second display window is added on the screen when detecting a frame on the screen of the mobile terminal is dragged. The initial position before dragging is close to or overlaps the outer frame of the screen, and the distance between the final position after dragging and the outer frame of the screen is greater than a threshold value. Not only can a plurality of windows be displayed on the screen of the mobile terminal, but the operation of adding windows can be implemented only by dragging the frame, overcoming the limitation that the screen must be divided to change the number of windows displayed, which enhances the customer experience.

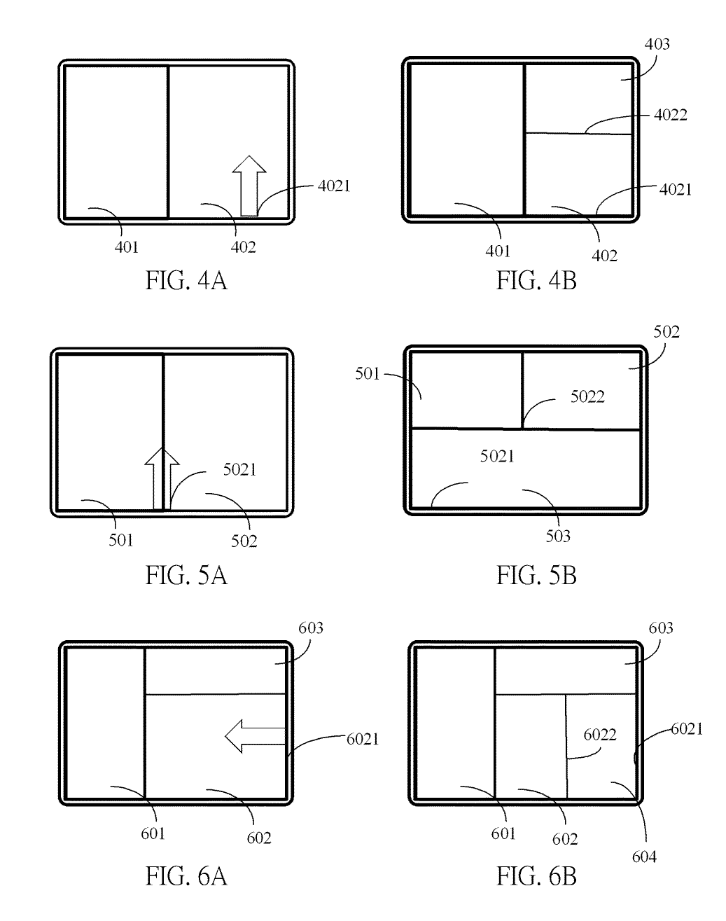

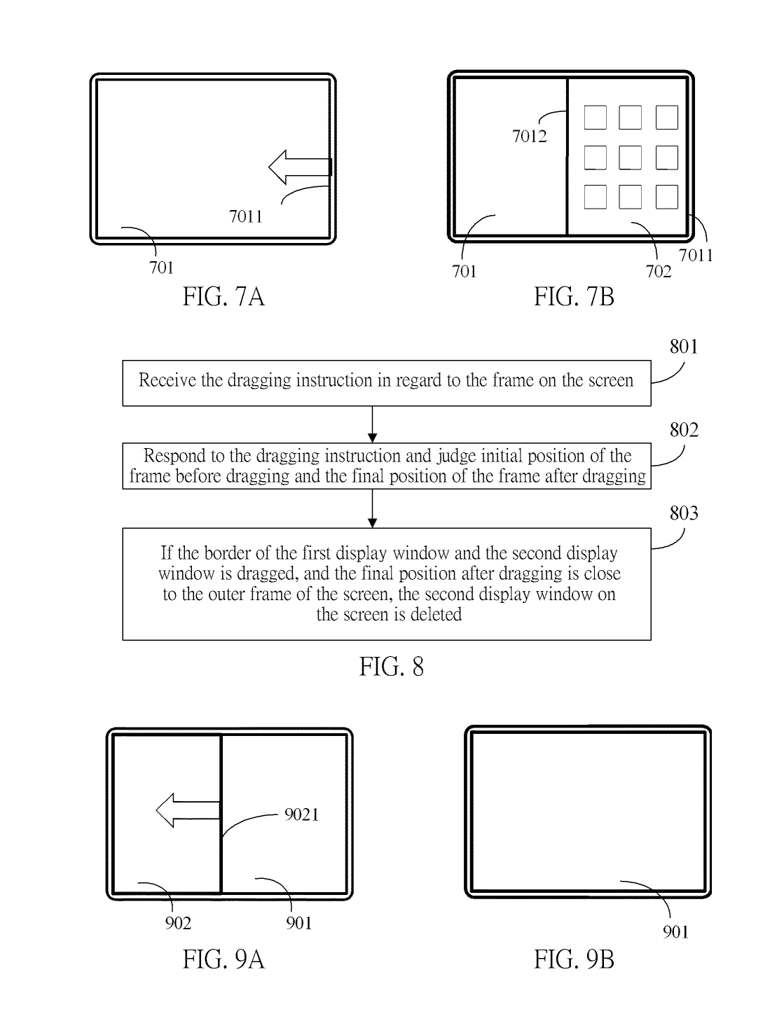

Another embodiment is shown in FIG. 8, which is a flowchart illustrating a processing method of screen-displayed windows according to another embodiment of the present invention, and comprises the steps 801 to 803:

Step 801: receive the dragging instruction in regard to the frame on the screen.

Step 802: respond to the dragging instruction and judge an initial position of the frame before dragging and the final position of the frame after dragging.

Step 803: if the first display window and the second display window are already displayed on the screen of the mobile terminal, if the initial position of the dragged frame before dragging is located at the border of the first window and the second window, and the final position after dragging is close to or overlaps the outer frame of the screen, then the second display window on the screen is deleted to reduce the number of display windows on the screen.

FIG. 9A and FIG. 9B are diagrams illustrating the adjustment of the number of display windows applying the embodiment illustrated in FIG. 8.

FIG. 9A is a diagram illustrating the first display window and the second display window displayed on the screen of the mobile terminal before dragging and FIG. 9B is a diagram illustrating the first display window displayed on the screen of the mobile terminal after dragging. The first display window and the second display window are defined as the window 901 and the window 902, respectively.

The window 901 and the window 902 are displayed on the screen of the mobile terminal. When the border 9021 of the window 901 and the window 902 is dragged, as shown in FIG. 9, the display area of the window 902 gets smaller in the process of the border 9021 being dragged toward the window 902. Correspondingly, the display area of the window 901 gradually gets bigger. In a preferred embodiment, the content displayed in the window 902 gets smaller along with the deflation of the window, but display content is displayed as completely as possible, and the content displayed in the window 901 gradually gets bigger with the enlargement of the window.

When the border is dragged to be close to or overlapping the outer frame of the screen parallel with the border, e.g. the outer frame on the left side of the screen, and after the dragging operation (i.e. the mobile terminal detects the release of the screen touch corresponding to dragging), the content displayed in the window 902 is not displayed on the screen of the mobile terminal anymore. At this time, the screen of the mobile terminal only displays the content displayed in the window 901.

The screen of the mobile terminal does not display the second display content displayed in the second display window, but the second display content displayed in the second display window is not closed; instead, it becomes the program operating in the background. This is illustrated in FIG. 9. When the display content of the display window 902 is not displayed on the screen of the mobile terminal anymore, the program corresponding to the display content of the window 902 becomes the program operating in the background.

In another embodiment, when the number of display windows displayed on the screen of the mobile terminal is greater than two, e.g. the first display window, the second display window and the third display window are displayed on the screen of the mobile terminal in the same time, when the border of any two windows is dragged to be close to or overlapping the outer frame of the screen parallel with the border, the screen will not display the window passed by the border in the dragging process.

FIG. 10A and FIG. 10B are diagrams illustrating the adjustment of the number of display windows applying the embodiment of FIG. 8. FIG. 10A is a diagram illustrating a first display window, a second display window and a third display window displayed on the screen of the mobile terminal before dragging and FIG. 10B is a diagram illustrating a first display window and a second display window displayed by the mobile terminal after dragging. For ease of description, the first display window, the second display window and the third display window are defined as the window 1001, the window 1002 and the window 1003, respectively.

As shown in FIG. 10A, the border 10021 of the window 1002 and the window 1003 is dragged toward the window 1002. When the border 10021 is dragged to be close to or overlapping the bottom of the outer frame of the screen, after dragging (i.e. when the mobile terminal detects the dragging process is over), the screen of the mobile terminal does not display the content displayed in the window 1002. Instead, the position of the window 1002 is overlapped by the window 1003. Accompanying the dragging process, the proportion of the content displayed in the window 1003 will gradually get bigger with the enlargement of the display area of the window. After dragging, the mobile terminal has only two display windows, i.e. the content displayed in the display windows 1001 and 1003.

In the dragging process of the border, the dragging direction is only an example, and not a limitation. The dragging direction should be in the same direction as the direction of the boarder. Any method of dragging the border of a plurality of windows displayed on the screen of the mobile terminal towards the outer frame of the screen of the mobile terminal to reduce the number of displayed windows should fall within the scope of the present invention. Compared with the prior art, in this embodiment, if the first display window and the second window are displayed on the current screen of the mobile terminal, when dragging the border of the first display window and the second display window and when the final position after dragging is close to or overlaps the outer frame of the screen, the second display window is deleted from the screen to reduce the number of displayed windows. Through the abovementioned method, not only can a plurality of windows be displayed on the screen of the mobile terminal, but the operation of reducing the number of windows can be implemented via dragging the frame of the display window, which overcomes the limitation that the screen should be divided to change the number of displayed windows, which enhances the customer experience.

In another embodiment, if the final position of the border of the first display window and the second display window after dragging is not close to or does not overlap the outer frame of the screen, when the release of the dragging border is detected, the display proportion of the first display window and the second display window is adjusted according to the final position of the border after dragging.

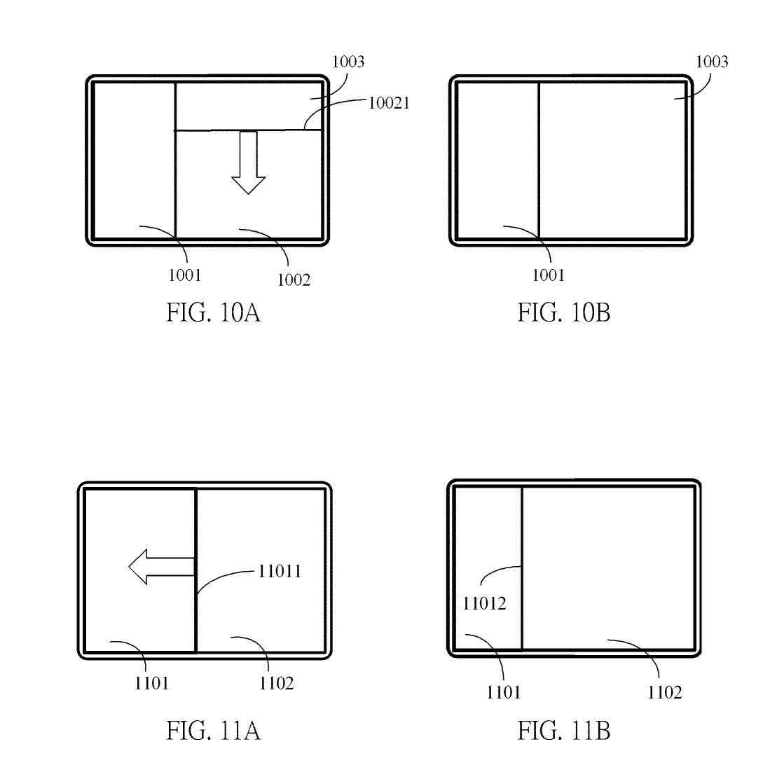

FIG. 11A and FIG. 11B are diagrams illustrating the adjustment of the area of the screen-displayed window according to an embodiment. FIG. 11A is a diagram illustrating the first display window and the second display window displayed on the screen of the mobile terminal before dragging and FIG. 11B is a diagram illustrating the first display window and the second display window displayed by the mobile terminal after dragging. The first display window and the second display window are defined as the window 1101 and the window 1102, respectively.

When the border 11011 of the window 1101 and the window 1102 is dragged, and the dragging distance is greater than the second threshold value wherein the value is not limited as long as it can be recognized by the mobile terminal, e.g. 1 cm, and if the final position of the border 11011 after dragging is not close to the outer frame parallel with the border, the mobile terminal only needs to rearrange the proportion of the content displayed in the windows 1101 and 1102 according to the area of the adjusted windows 1101 and 1102, and preferably displays all the wanted contents on each screen.

In another embodiment, if the border is dragged, the area occupied by the first display window is relatively small as shown in FIG. 11. After dragging, the display area of the window 1101 is smaller, so that reading of the content displayed in the window 1101 will be affected when all the content is displayed. Then, after adjusting, only a portion of the first display content is displayed in the first display window to make sure the customer can watch the wanted content displayed in the first display window. This function is necessary under some conditions. In an embodiment, when the program corresponding to the first display window is executed automatically and the customer is notified of the status of the processing of the program via a portion of the screen (for example, the program displayed in the first display window is updating or downloading), the customer will only be concerned with the progress bar during the waiting process. During this time, the proportion of the first display window to the second display window is adjusted via dragging the border of the two windows, e.g. the content of the program corresponding to the second display window is enlarged and the first display window is shrunk, to display the concerned part and use the screen of the mobile terminal efficiently.

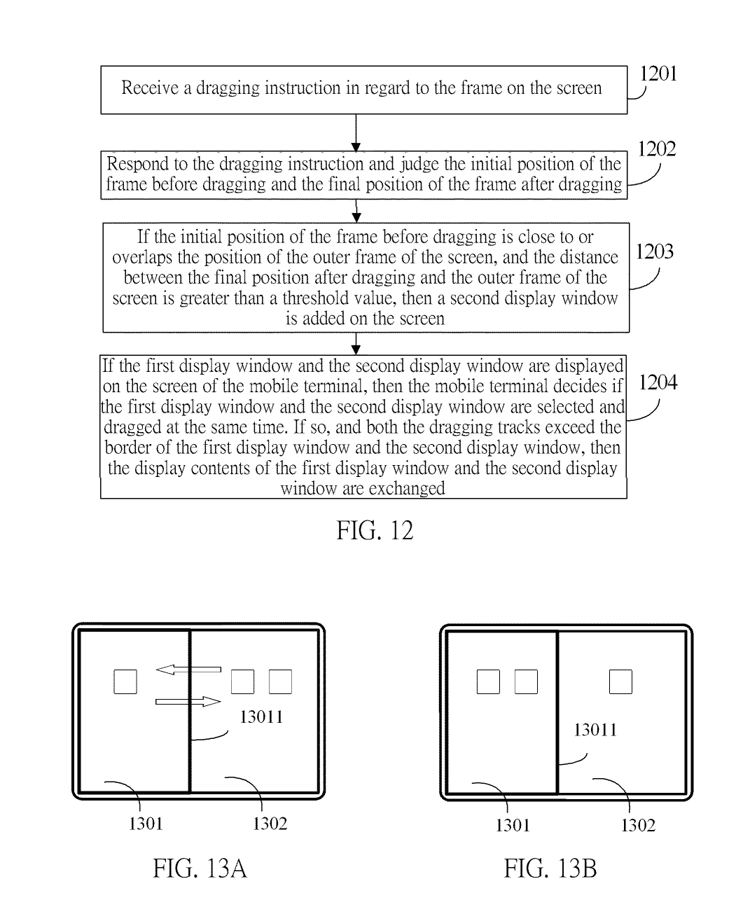

Another embodiment is shown in FIG. 12, which is a flowchart illustrating a processing method of screen-displayed windows. Compared to the processing method described in FIG. 1, the processing method in this embodiment is based on the processing method described in FIG. 1 and further comprises step 1204, which is described as follows:

Step 1204: if the first display window and the second display window are displayed on the screen of the mobile terminal, then the mobile terminal decides if the first display window and the second display window are selected and dragged at the same time. If so, and both the dragging tracks exceed the border of the first display window and the second display window, then the display contents of the first display window and the second display window are exchanged.

FIGS. 13A and 13B are diagrams illustrating the exchange of content of the screen displayed window, wherein FIG. 13A is a diagram illustrating the first display window and the second display window displayed on the screen of the mobile terminal before dragging and FIG. 13B is a diagram illustrating the first display window and the second display window displayed by the mobile terminal after dragging. The first display window and the second display window are defined as the window 1301 and the window 1302, respectively, and the relative position of the window 1301 and the window 1302 is an example, not a limitation.

As shown in FIG. 13A, the window 1301 and the window 1302 are selected at the same time, wherein the selection can be implemented by a touch. When the two selected windows 1301 and 1302 are dragged at the same time, and the dragging tracks of both windows exceed the border 13011 between the window 1301 and the window 1302, the contents displayed in the window 1301 and the window 1302 are exchanged, i.e. the window 1301 displays the content which was displayed in the window 1302 before dragging and the window 1302 displays the content which was displayed in the window 1301 before dragging.

When more than two windows are displayed on the screen of the mobile terminal at the same time, the exchange of the display content can also be implemented by the abovementioned method. FIGS. 14A and 14B are diagrams illustrating the exchange of content of the screen displayed window, wherein FIG. 14A is a diagram illustrating the content of the first display window, the content of the second display window and the content of the third display content displayed on the screen before dragging and FIG. 14B is a diagram illustrating the content of the first display window, the content of the second display window and the content of the third display content displayed on the screen after dragging. The window 1401, the window 1402 and the window 1403 are arranged to represent the first display window, the second display window and the third display window, respectively.

If two selected windows 1403 and 1402 are dragged at the same time, and the dragging tracks of both windows exceed the border 14031 of the window 1403 and the window 1402, the content displayed in the window 1402 and the window 1403 are exchanged, i.e. the window 1403 displays the content which was displayed in the window 1402 and the window 1402 displays the content which was displayed in the window 1403. Meanwhile, the content displayed in the window 1401 is maintained.

Compared with the prior art, when the first display window and the second display window displayed on the screen of the mobile terminal are selected at the same time, and the dragging tracks of both windows exceed the border of the first display window and the second display window, the content displayed in the first display window and the second display window are exchanged. Through the abovementioned method, not only can a plurality of windows be displayed on the screen of the mobile terminal, but the adjacent windows can exchange the contents by dragging, which is a fast operation that can thereby enhance the customer experience.

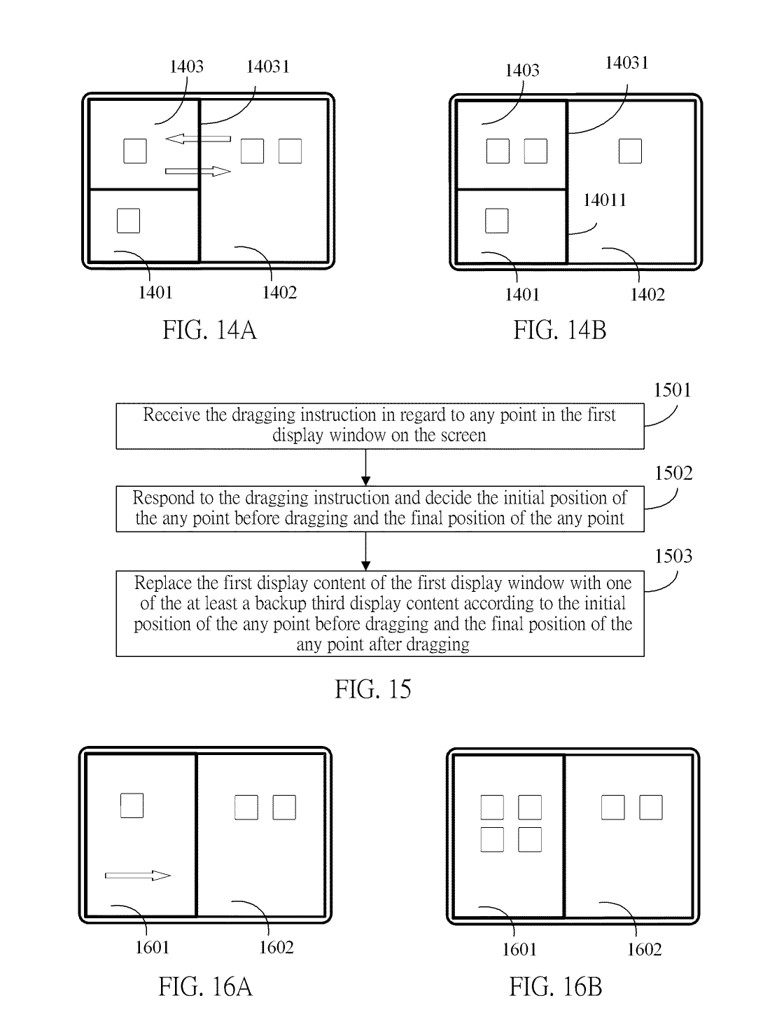

FIG. 15 is a flowchart illustrating a processing method of windows displayed on the screen according to another embodiment of the present invention. This embodiment comprises the following steps:

Step 1501: receive the dragging instruction in regard to any point in the first display window on the screen.

When the first display window and at least a second display window are displayed on the screen of the mobile terminal, the first display window displays the first display content, each second display window displays the corresponding second display content, the background of the mobile terminal comprises at least a backup third display content, and when the mobile terminal detects the dragging instruction in regard to the screen from the customer, the dragging instruction in regard to any point in the first display window on the screen is received. More particular, when a touch point of the user's finger on the screen locates on a frame, such as a frame of a display window or the outer frame of the screen, the mobile terminal will not decide that the dragging instruction is regarding to one point. Otherwise, the mobile terminal will decide that the dragging instruction is regarding to one point.

Step 1502: respond to the dragging instruction and decide the initial position of the point before dragging and the final position of the point after dragging on the screen.

The mobile terminal confirms the initial position and the final position according to the abovementioned dragging instruction.

Step 1503: replace the first display content of the first display window with one of the backup third display content according to the initial position of the point and the final position of the point.

When the distance between the initial position and the final position is greater than the second threshold value, and the initial position and the final position are both located in the first display window and are not close to the frame of the first display window, the first display content displayed in the first display window is replaced with the backup third display content operating in the background of the mobile terminal.

The first display content, at least a second display content and at least a backup third display content are arranged as a sequence of display content according to the order of the display content opened by the mobile terminal. For example, a set of pictures, experimental results in different periods or other information which is consecutive in time.

FIGS. 16A and 16B are diagrams illustrating the adjustment of the number of display windows applying the processing method of FIG. 15, wherein FIG. 16A is a diagram illustrating the content displayed in the first display window and the content displayed in the second display window displayed on the screen of the mobile terminal before dragging and FIG. 16B is a diagram illustrating the content displayed in the first display window and the content display in the second display window displayed on the screen of the mobile terminal after dragging. The window 1601 and the window 1602 are arranged to define the first display window and the second display window, respectively.

When the mobile terminal detects any point in the window 1601 is dragged and confirms the initial position before dragging and the final position after dragging, it decides if the dragging distance exceeds a threshold value, e.g. 0.5 cm, according to the initial position and the final position. If so, the display content of the window 1601 is replaced with the display content separate from the least display content in the sequence of display content. In a specific embodiment, if the final position of the any point in the window 1601 is located underneath or on the left side of the initial position, the content displayed in the window 1601 is replaced with the content of the program opened before the window 1601. If the final position of the any point in the window 1601 is located above or on the right side of the initial position, the content displayed in the window 1601 is replaced with the content of the program opened after the window 1601. As shown in FIG. 16A, if the first display content displayed in the first display window 1601 corresponds to the program A_{N}, the second display content displayed in the second display window 1602 corresponds to the program A_{N-1}. At this time, the background of the mobile terminal comprises backup programs A₁, A₂, . . . A_{N-2}. Then, after detecting any point in the first display window 1601 is dragged for a distance, the display content of the first display window 1601 is replaced with the backup display content A_{N-2} shown in FIG. 16B. In other words, after detecting any point in the first display window 1601 is dragged for a distance, the display content of the first display window 1601 is replaced with the backup third display content which has a least interval from the first display content in the sequence of display contents and opened before the first display content.

The limitation of direction here is only an example. In other embodiments, the opposite direction or any other direction is feasible as long as it can be recognized and operated by the mobile terminal.

When the first display content displayed in the first display window is replaced with the third display content, the program corresponding to the first display content is not closed, but will operate in the background of the mobile terminal.

Compared with the prior art, the mobile terminal of this embodiment replaces the first display content of the first display window with one of the backup third display content via responding to the instruction of dragging any point in the first display window to the final position from the initial position. Not only can a plurality of windows be displayed on the screen of the mobile terminal at the same time, but replacing the content of the first display window with the backup third display content can be implemented by only dragging any point in the first display window. This operation is simple and convenient, and also overcomes the limitation that an additional taskbar needs to be installed on the screen to implement the replacement of content of each of the plurality of windows, which enhances the customer experience.

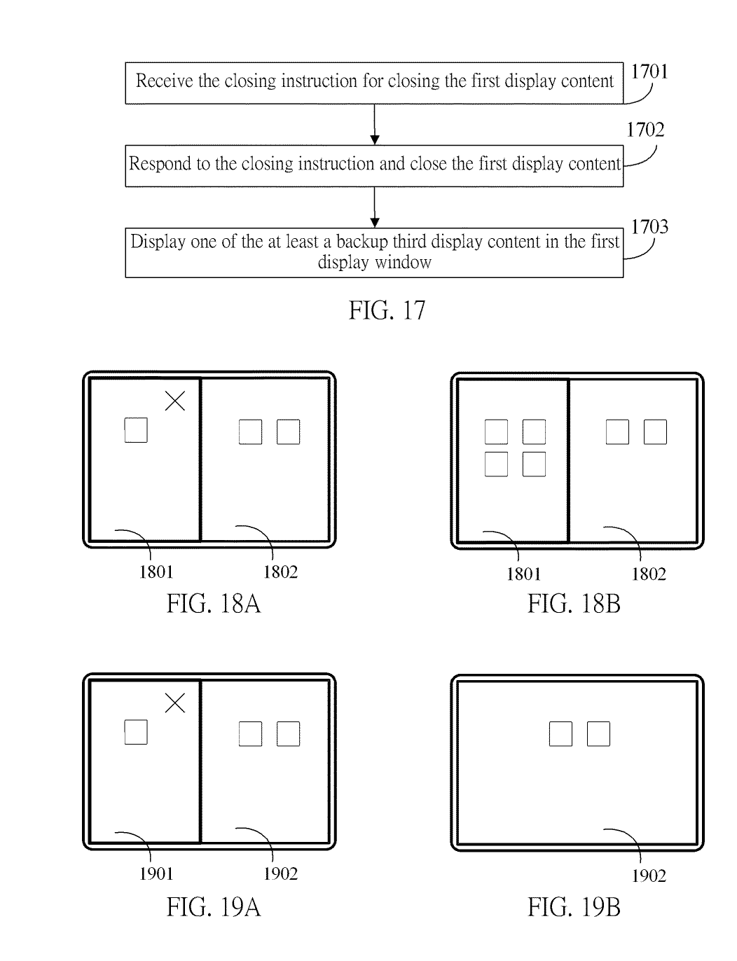

FIG. 17 is a flowchart illustrating a processing method of screen-displayed windows according to another embodiment of the present invention. The processing method of this embodiment comprises the following steps:

Step 1701: receive a closing instruction for closing the first display content.

Step 1702: respond to the closing instruction and close the first display content.

Step 1703: display one of the backup third display content in the first display window.

When the screen of the mobile terminal displays the first display window and at least a second display window, the first display window displays the first display content, each second display window displays the corresponding second display content, the background of the mobile terminal comprises at least a backup third display content when the mobile terminal detects the closing instruction for the first display content from the customer (for example, the closing instruction for closing the first display content is received when the customer clicks on the close button displayed on the first display screen). In step 1702, after closing the first display content displayed in the first display window, the first display window does not disappear along with the closure of the first display content. Instead, the first display window displays one of the backup third display content operating in the background of the mobile terminal.

FIGS. 18A and 18B are diagrams illustrating the adjustment of the number of display windows applying the processing method of FIG. 17. FIG. 18A is a diagram illustrating the screen of the mobile terminal before the first display content is closed and FIG. 18B is a diagram illustrating the screen of the mobile terminal after the first display content is closed. The window 1801 and the window 1802 are arranged to define the first display window and the second display window, and the contents displayed in the window 1801 and the window 1802 are arranged to define the first display content and the second display content, respectively.

When the content displayed in the window 1801 is closed by the mobile terminal, which can usually be done by clicking the close button on the page, the area of the window 1801 is not overlapped by the window 1802. At this time, the window 1801 displays one of the backup third display content separated from the previous display content with the least display content in the sequence of display content and opened before the first display content. As shown in FIG. 18A, if the first display content displayed in the first display window 1801 corresponds to the program A_{N}, and the second display content displayed in the second display window corresponds to the program A_{N-1}, the background of the mobile terminal comprises backup programs A₁, A₂, . . . , A_{N-2}. Then, after detecting the first display content of the first display window 1801 is closed, as shown in FIG. 18B, the display content of the first display window 1801 is replaced with the backup display content A_{N-2}.

Another embodiment is shown in FIG. 19A and FIG. 19B which are diagrams illustrating the adjustment of the number of display window, wherein FIG. 19A is a diagram illustrating the screen of the mobile terminal before the first display content is closed and FIG. 19B is a diagram illustrating the screen of the mobile terminal after the first display content is closed. For ease of description, the window 1901 and the window 1902 are arranged to define the first display window and the second display window, and the contents displayed in the window 1901 and the window 1902 are arranged to define the first display content and the second display content, respectively. If the backup third display content is separated from the window 1901 with the least display content in the sequence of display content and opened before the first display content does not exist, then after closing the content displayed in the window 1901, the display area of the window 1901 is overlapped by the area of the window 1902.

In another embodiment, when the number of windows displayed on the desktop is greater than two, the area of the first display window is replaced with the adjacent second display window when the first display window is closed. The method is similar to the FIG. 19, so the detailed description is omitted here. In addition, in the processing method described in FIG. 17 to FIG. 19, the program corresponding to the closed first display content is deleted from the sequence of programs opened by the customer.

Compared with the prior art, the mobile terminal of this embodiment replaces the first display content of the first display window with one of at least a backup third display content via responding to the instruction for closing the first display content displayed in the first display window on the screen of the mobile terminal. Not only can a plurality of windows be displayed on the screen of the mobile terminal, but the replacement of the third display content can be implemented by closing the first display content, which is a simple operation that enhances the customer experience.

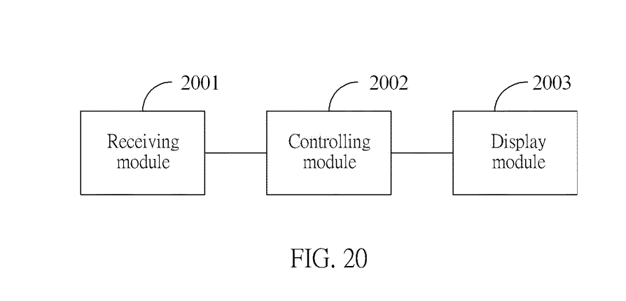

FIG. 20 is a diagram illustrating the structure of the mobile terminal according to an embodiment of the present invention. The mobile terminal of this embodiment comprises the receiving module 2001, the controlling module 2002 and the display module 2003, wherein the receiving module 2001 is arranged to receive the instruction from a customer, the controlling module 2002 is arranged to control the operations of the receiving module 2001 and the display module 2003, and the display module 2003 is arranged to display a plurality of windows and content of windows on the screen. The mobile terminal in FIG. 20 can implement the processing method of screen windows described in FIG. 1 to FIG. 19, so the specific executing step is omitted here. In addition, the mobile terminal shown in FIG. 20 can be implemented by software, hardware and firmware, which all fall within the scope of the present invention.

In an example, the receiving module 2001 is arranged to receive the dragging instruction in regard to the frame of the screen, the controlling module 2002 is arranged to respond to the dragging instruction and judge the initial position of the frame before dragging and the final position of the frame after dragging on the screen, and the display module 2003 is arranged to add a second display window in addition to the first display window on the screen when the initial position of the frame is close to or overlaps the outer frame of the screen, and the distance between the final position and the outer frame of the screen is greater than a threshold value.

In another example, after the controlling module 2002 confirms the initial position before dragging and the final position after dragging according to the dragging instruction, the display confirms the number of display windows that should be displayed on the screen according to the initial position and the final position of the frame.

In addition, the display module 2003 is also arranged to display at least a first display window and a second display window on the screen in the same time when the controlling module 2002 uses the initial position before dragging as a border of the first display window and the final position after dragging as the border of the first display window and the second display window. The display module 2003 is also arranged to keep the first display window and the second display window displaying on the screen at the same time after the controlling module 2002 detects the release of a screen touch corresponding to the dragging operation.

In the dragging process of the first display window, the first display content of the first display window is shrunk proportionally and dynamically according to the position of the dragged frame. Correspondingly, after the second display window is generated, the second display content displayed in the second display window enlarges proportionally along with the dragging process. When the frame arrives at a specific position and starts to move back, the first display content of the first display window enlarges dynamically and proportionally according to the position after dragging, and the second display content displayed in the corresponding second display window is shrunk proportionally.

In another embodiment, after the controlling module 2002 confirms the final position of the dragged frame after dragging is located on the right side of the initial position before dragging, then the display module 2003 is arranged to make the second display content displayed in the second display window be the content corresponding to the program opened before the first display content opened by the mobile terminal. Preferably, the opened program is the program opened before the first display content and the opening time is the closest to the opening time of the first display content.

In other embodiments, after the controlling module 2002 confirms the final position of the dragged frame after dragging is located above the initial position, then the display module 2003 is arranged to make the second display content displayed in the second display window be the content corresponding to the program opened before the first display content opened by the mobile terminal, wherein the opened program is the program opened before the first display content and the opening time is the closest to the opening time of the first display content.

In the present invention, the direction from the ignition position before dragging to the final position after dragging is relative. In other embodiments, as long as the dragging direction is regular and recognizable by the mobile terminal, it is not limited.

In another embodiment, after the controlling module 2002 confirms the final position of the dragged frame after dragging is located on the left side of the initial position before dragging, if the current first display content displayed in the first display window is the newest program, the display module 2003 is arranged to make the second display window display the desktop of the mobile terminal.

If the current first display window of the mobile terminal is not the newest program, then the second display content displayed in the second display window is the display content corresponding to the program opened after the first display content. Preferably, the opened program is the program opened after the first display content and the opening time is the closest to the opening time of the first display content.

In addition, the first display window and the second display window displayed by the mobile terminal are not limited; in other embodiments, even if three display windows are already displayed on the screen of the mobile terminal, a fourth, fifth or even more display windows can be added, and the number is not limited.

In the abovementioned method of adding windows via dragging the frame, the dragging direction described in the embodiment is only an example, and not a limitation. In other embodiments, any method of adding screen display windows via dragging should fall within the scope of the present invention.

In another embodiment, the display module 2003 is arranged to delete the second display window to reduce the number of display windows on the screen when the first display window and the second display window are displayed, and the initial position of the dragged frame of the first display window before dragging is located at the border of the first display window and the second display window, and the finial position after dragging is close to the outer frame of the screen.

More specifically, when the border of the first display window and the second display window is dragged, the display module 2003 is arranged to make the first display content displayed in the first display window enlarge proportionally according to the area of the current first display window. Correspondingly, the content displayed in the second display window is shrunk proportionally, and when the border is dragged to where is close to or overlaps the position of the outer frame parallel with the border and after the mobile terminal detects the release of a screen touch corresponding to the dragging operation, the screen does not display the second display content of the second display window anymore, and only the first display content will be displayed in the first display window.

The second display content displayed in the second display window is not displayed on the screen of the mobile terminal anymore, but the second display content displayed in the second display window is also not closed, and still belongs to the opened program.

In another embodiment, when final position of the border of the first display window and the second display window after dragging is not close to or does not overlap the outer frame of the screen and after the controlling module 2002 detects the release of the dragging border, the display module 2003 is arranged to adjust the display proportions of the first display window and the second display window according to the final position of the border.

Preferably, after adjusting, the display proportion of the first display content displayed in the first display window is changed according to the position of the first display window so that all the content can be displayed.

In another embodiment, if the area occupied by the first display window is relatively small after the border is dragged, and reading of the first display content is affected when all the content is displayed or displaying all the content is not necessary, then only a portion of the first display content is displayed in the first display window after adjusting.

In another embodiment, the display module 2003 is arranged to exchange the contents of the first display window and the second display window when the current screen of the mobile terminal displays the first display window and the second display window, the controlling module 2002 confirms the first display window and the second display window are selected and dragged in the same time, and the dragging tracks of both windows exceed the border of the first display window and the second display window.

In another embodiment, when the first display window and at least a second display window are displayed on the screen of the mobile terminal in the same time, the first display window displays the first display content, each second display window displays the corresponding second display content, and the background of the mobile terminal comprises at least a backup third display content, the receiving module 2001 is arranged to receive the dragging instruction in regard to any point in the first display window on the screen.

The controlling module 2002 is arranged to respond to the dragging instruction and decide the initial position of the point before dragging and the final position of the point after dragging on the screen.

After the receiving module 2001 receives the abovementioned instruction, the controlling module 2002 confirms the initial position before dragging and the final position after dragging in this dragging process according to the abovementioned instruction.

The display module is arranged to replace the first display content of the first display window with one of the backup third display content according to the initial position of the point before dragging and the final position of the point after dragging.

More specifically, when the controlling module 2002 detects the distance between the initial position before dragging and the final position after dragging is greater than a threshold value, and the final position and the initial position are both located in the first display window and are not close to the outer frame of the screen, the display module 2003 is arranged to replace the first display content displayed in the first display window with at least a backup third display content operating in the background of the mobile terminal.

The first display content, at least a second display content and at least a backup third display content are arrange in a sequence of display content according to the order of the display content opened by the mobile terminal. For example, a set of pictures, experimental results in different periods or other information which is consecutive in time.

Furthermore, after the controlling module 2002 confirms the initial position of the point before dragging and the final position of the point after dragging according to the dragging instruction, if the final position of the point is located underneath or on the left side of the initial position of the point, the display module 2003 is arranged to replace the first display content on the screen of the mobile terminal with the backup third display content separated from the first display content with the least display content in the sequence of display content and opened after the first display content.

When the controlling module 2002 confirms that the final position of any point after dragging is located above or on the right side of the initial position of the point before dragging according to the dragging instruction, the display module 2003 is arranged to replace the first display content with the backup third display content separate from the first display content with the least display content in the sequence of display content and opened before the first display content.

In another embodiment, when the first display window and at least a second display window are displayed on the screen at the same time, and the first display window displays the first display content, each second display window displays corresponding second display content, and the background of the mobile terminal comprises at least a backup third display content, the receiving module 2001 is arranged to receive the closing instruction for closing the first display content.

The controlling module 2002 is arranged to respond to the closing instruction and close the first display content.

After the receiving module 2001 receives the closing instruction, the controlling module 2002 confirms the display window which needs to be closed is the first display content according to the closing instruction, then responds to the closing instruction and closes the first display content displayed in the first display window.

The display module 2003 is arranged to display a backup third display content in the first display window.

More specifically, after the first display content displayed in the first display window is closed by the mobile terminal, a backup third display content displayed in the first display content is the backup third display content separate from the first display content with the least display content in the sequence of display content and opened before the first display content.

In another embodiment, if the backup third display content separate from the first display content and having the least display content in the sequence of display content and opened before the first display content does not exist, then the first display window is closed to make the second display window overlap the area of the first display window.

As compared to the prior art, the mobile terminal uses a controlling module to respond to customer instructions received by a receiving module and change the number of windows displayed on the screen of the mobile terminal and the display content displayed in the window. Through this method, not only is a simple method of changing a number of windows on the screen provided, but the invention can also overcome the limitation that an additional taskbar is needed to change the display content of each window. The operation according to the disclosure is simple and convenient, and enhances a customer experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processing method for windows displayed on a screen, wherein a first display window is displayed on the screen and the first display window comprises a first frame and displays a first display content, the method comprising:
receiving a dragging instruction in regard to a frame on the screen;
responding to the dragging instruction and deciding an initial position of the frame before dragging and a final position of the frame after dragging on the screen;
when the initial position of the frame is close to or overlaps a position of an outer frame of the screen, a second display window is added on the screen.

2. The processing method of claim 1, wherein the step of adding the second display window on the screen comprises:
locating a border between the first display window and the second display window with the final position of the frame, and displaying at least the first display window and the second display window on the screen at the same time, and after detecting a release of a screen touch corresponding to the dragging operation, keeping the first display window and the second display window displaying on the screen at the same time.

3. The processing method of claim 2, wherein the first display content of the first display window is shrunk proportionally during the dragging process of the frame.

4. The processing method of claim 2, wherein a second display content is displayed in the second display window and the method further comprises:
when the final position of the frame is located on the right side of the initial position, then the second display content displayed in the second display window is the display content of a program corresponding to the window opened before a program corresponding to the first display content opened by the mobile terminal; and
when the final position of the frame is located on the left side of the initial position, then the second display content of the second display window is a desktop of the mobile terminal or the display content of a program corresponding to the window opened after the program corresponding to the first display content opened by the mobile terminal.

5. The processing method of claim 4, wherein when the final position of the frame is located on the left side of the initial position of the frame, if the display content corresponding to the window opened after the first display content opened by the mobile terminal exists, then the second display content displayed in the second display window is the display content of the program corresponding to the window opened after the program corresponding to the first display content, and if the display content corresponding to the window opened after the first display content opened by the mobile terminal does not exist, then the second display content displayed in the second display window is the desktop of the mobile terminal.

6. The processing method of claim 1, wherein the first display window and the second display window are displayed on the screen at the same time, and when the initial position of the frame is located at a border of the first display window and the second display window, and the final position is close to or overlaps the outer frame of the screen, then the second display window is deleted from the screen to reduce the number of display windows on the screen.

7. The processing method of claim 6, wherein the step of deleting the second display window from the screen comprises:
using the final position of the frame after dragging as a border of the first display window, enlarging the first display content of the first display window, and after detecting a release of the screen touch, stopping displaying the second display content of the second display window on the screen.

8. The processing method of claim 1, wherein the first display window and the second display window are displayed on the screen and the method further comprises detecting if the first display window and the second display window are selected and dragged at the same time, wherein when they are selected and the dragging tracks of both windows exceed a border of the first display window and the second display window, then the contents of the first display window and the second display window are exchanged.

9. The processing method of claim 1, wherein the first display window and the second display window are displayed on the screen and the method further comprises when the initial position of the frame is located at a border of the first display window and the second display window, and the final position of the frame is not close to or does not overlap the outer frame of the screen, then after detecting a release of the dragged frame, the display proportions of the first display window and the second display window are adjusted according to the final position of the frame.

10. The processing method of claim 9, wherein a portion of the first display content is displayed in the adjusted first display window.

11. A processing method for windows displayed on the screen, wherein a first display window and at least a second display window are displayed on a screen of a mobile terminal, the first display window displays a first display content and each second display window displays a corresponding second display content, and a background of the mobile terminal comprises at least one backup third display content, the processing method comprising:
receiving a dragging instruction in regard to any point in the first display window on the screen;
responding to the dragging instruction and deciding an initial position of the point before dragging and a final position of the point after dragging on the screen; and
replacing the first display content of the first display window with the at least one backup third display content according to the initial position of the point and the final position of the point.

12. The processing method of claim 11, wherein the first display content, the second display content and the backup third display content are arranged to be a sequence of display contents according to an order of display content of programs opened by the mobile terminal, and the step of replacing the first display content of the first display window with the backup third display content comprises:
when the final position of the point is located underneath or on the left side of the initial position of the point, replacing the first display content with the backup third display content which has a least interval from the first display content in the sequence of display contents and opened after the first display content; and
when the final position of the point is located above or on the right side of the initial position of the point, replacing the first display content with the backup third display content which has a least interval from the first display content in the sequence of display contents and opened before the first display content.

13. A processing method for windows displayed on the screen, wherein a first display window and at least a second display window are displayed on a screen, the first display window displays a first display content, each second display window displays a corresponding second display content, and a background of the mobile terminal comprises at least one backup third display content, the processing method comprising:
receiving a closing instruction for closing the first display content;
responding to the closing instruction and closing the first display content; and
displaying one of the backup third display content in the first display window.

14. The processing method of claim 13, wherein the step of displaying the backup third display content in the first display window comprises:
the backup third display content is the backup third display content which has a least interval from the first display content in a sequence of display contents and opened before the first display content.

15. The processing method of claim 14, wherein when the backup third display content which has the least interval from the first display content in a sequence of display contents and opened before the first display content does not exist, then the first display window is closed to make the second display window overlap a area of the first display window.

16. A mobile terminal, comprising:
a screen, wherein a first display window is displayed on the screen, and wherein the first display window comprises a first frame and displays a first display content;
a receiving module;
a controlling module; and
a display module;
wherein the receiving module is arranged to receive a dragging instruction in regard to a frame on the screen, the controlling module is arranged to respond to the dragging instruction and judge an initial position of the frame before dragging and a final position of the frame after dragging on the screen, and the display module is arranged to add a second display window on the screen when the initial position of the frame is close to or overlaps an outer frame of the screen and the distance between the final position after dragging and the outer frame of the screen is greater than a threshold value.

17. The mobile terminal of claim 16, wherein the display module is arranged to display the first display window and the second display window on the screen at the same time when the controlling module detects the final position of the frame is located at a border of the first display window and the second display window, and the display module is also arranged to keep the first display window and the second display window displaying on the screen at the same time after the controlling module detects a release of a screen touch corresponding to the dragging.

18. The mobile terminal of claim 17, wherein the controlling module is also arranged to shrink the first display content of the first display window during the dragging process of the frame, and the display module is arranged to correspondingly display the first display content.

19. The mobile terminal of claim 17, wherein the display module is also arranged to display the second display content in the second display window, when the final position of the frame is located on the right side of the initial position, the second display content displayed in the second display window is the display content of a program corresponding to the window opened before a program corresponding to the first display content opened by the mobile terminal;
when the final position of the frame is located on the left side of the initial position, the display module is also arranged to make the second display content displayed in the second display window be a desktop of the mobile terminal, or the display content of the program corresponding to the window opened after the program corresponding to the first display content opened by the mobile terminal.

20. The mobile terminal of claim 19, wherein the display module is also arranged to make the second display content displayed in the second display window be the display content of the program corresponding to the window opened after the program corresponding to the first display content opened by the mobile terminal when the display content corresponding to the window opened after the first display content opened by the mobile terminal exists, and the display module is also arranged to make the second display content displayed in the second display window be the desktop of the mobile terminal when the display content corresponding to the window opened after the first display content opened by the mobile terminal does not exist.

21. The mobile terminal of claim 16, wherein the display module is also arranged to display the first display window and the second display window on the screen at the same time, when the initial position of the frame is located at a border of the first display window and the second display window, and the final position is close to or overlaps the outer frame of the screen, the second display window is deleted from the screen to reduce a number of display windows on the screen.

22. The mobile terminal of claim 21, wherein the controlling module is arranged to use the final position of the frame as a border of the first display window and enlarge the first display content of the first display window proportionally in the dragging process of the frame, and the display module is also arranged to stop displaying the second display content of the second display window after detecting a release of a screen touch corresponding to the dragging.

23. The mobile terminal of claim 16, wherein the first display window and the second display window are displayed on the screen, the controlling module is also arranged to detect if the first display window and the second display window are selected and dragged at the same time in the mobile terminal, and the display module is arranged to exchange the display contents of the first display content and the second display content when the controlling module detects the first display window and the second display window are selected and dragged at the same time, and the dragging tracks of both windows exceed a border of the first display window and the second display window.

24. The mobile terminal of claim 16, wherein the first display window and the second display window are displayed on the screen, the controlling module is also arranged to adjust the display proportions of the first display window and the second display window according to the final position of the frame when the initial position of the frame is located at a border of the first display window and the second display window and the final position of the frame is not close to or does not overlap the outer frame of the screen, and after detecting a release of the dragged frame.

25. The mobile terminal of claim 24, wherein the display module is also arranged to display a portion of the first display content in the adjusted first display window.

26. A mobile terminal, comprising:
a receiving module;
a controlling module; and
a display module;
wherein when a first display window and at least a second display window are displayed on a screen of the mobile terminal, and the first display window displays a first display content, each second display window displays a corresponding second display content, and the background of the mobile terminal comprises at least one backup third display content, the receiving module is arranged to receive a dragging instruction in regard to any point in the first display window on the screen; the controlling module is arranged to respond to the dragging instruction and decide an initial position of the point before dragging and a final position of the point after dragging on the screen; and the display module is arranged to replace the first display content of the first display window with one of the backup third display contents according to the initial position of the point and the final position of the point.

27. The mobile terminal of claim 26, wherein when the final position of the point is located underneath or on the left side of the initial position of the point, the display module is arranged to replace the first display content with the backup third display content which has a least interval from the first display content with a least display content in a sequence of display contents and opened after the first display content; and when the final position of the point is located above or on the right side of the initial position of the point, the display module is arranged to replace the first display content with the backup third display content which has a least interval from the first display content in the sequence of display content and opened before the first display content.

28. A mobile terminal, comprising:
a receiving module;
a controlling module; and
a display module;
wherein when a first display window and at least a second display content are displayed on a screen, the first display window displays a first display content, each second display window displays a corresponding second display content, and a background of the mobile terminal comprises at least one backup third display content, the receiving module is arranged to receive a closing instruction for closing the first display content, the controlling module is arranged to respond to the closing instruction for closing the first display content, and the display module is arranged to display one of the backup third display content in the first display window.

29. The mobile terminal of claim 28, wherein the one of the backup third display content is the backup third display content which has a least interval from the first display content in a sequence of display contents and opened before the first display content.

30. The mobile terminal of claim 29, wherein the display module is arranged to close the first display window when the backup third display content which has the least interval from the first display content in a sequence of display contents and opened before the first display content does not exist to make the second display window overlap a area of the first display window.
